(19) United States
(12) Patent Application Publication
(10) Pub. No.: US 2009/0315937 A1
(43) Pub. Date: Dec. 24, 2009

(54) INK JET RECORDING APPARATUS

(75) Inventors: Atsushi Kubota, Sunto-gun (JP); Kazuhiko Ohtsu, Mishima-shi (JP); Takashi Kado, Izunokuni-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/472,616

(22) Filed: May 27, 2009

Related U.S. Application Data
(60) Provisional application No. 61/073,977, filed on Jun. 19, 2008.

(51) Int. Cl. B41J 2/205

(52) U.S. Cl. 347/15

(57) ABSTRACT

An ink jet recording apparatus includes a color processing unit that converts print data to color data, a reaction liquid ejecting unit that has plural nozzles arranged and ejects a reaction liquid onto a recording medium, an ink ejecting unit that has plural nozzles arranged and ejects an ink onto the recording medium based on the color data, a subscanning driving unit that conveys the recording medium having an image formed by the ink ejecting unit, and a controlling unit that controls to a constant value a ratio of an amount of droplets of the reaction liquid ejected by the reaction liquid ejecting unit and a total amount of ink droplets of the ink ejected by the ink ejecting unit, with respect to each of pixels of the image formed on the recording medium.

### CROSS-REFERENCE TO RELATED APPLICATION

This application claims the benefit of U.S. Provisional Application No. 61/073,977, filed Jun. 19, 2008.

### TECHNICAL FIELD

The present invention relates to an ink jet recording method and an ink jet recording apparatus, in which a reaction liquid and an ink composition are attached to a recording medium for recording.

### BACKGROUND

An ink jet recording apparatus is capable of recording a high definition image at a high speed. An ink jet recording apparatus forms reduced noise owing to the non-impact system thereof. Furthermore, an ink jet recording apparatus has such an advantage that a color image can be easily recorded by using inks of plural colors. Accordingly, an ink jet recording apparatus is widely used in offices and home.

A conventional ink jet recording apparatus often employs an ink jet recording method, in which droplets of an ink composition are flown and adhered to a recording medium, such as paper, to print an image. The method has a characteristic feature that an image with high resolution and high quality can be printed at high speed with a relatively inexpensive apparatus. The ink composition used in this method generally contains water as a major component, to which a coloring component and a moistening agent, such as glycerin, for preventing clogging are added.

Recently, JP-A-5-202328 proposes an ink jet recording method that uses two liquids including an ink composition and a reaction liquid containing a component that thickens or agglomerates the components in the ink composition.

In the method, for example, after applying a polyvalent metallic salt solution to a recording medium, an ink composition containing a dye having at least one carboxyl group is applied to the recording medium, and thus an insoluble composite is formed from the polyvalent metallic ion and the dye on the recording medium. There is disclosed that the insoluble composite provides a high quality image having water resistance without color bleed. JP-A-3-240557 and JP-A-3-240558 propose an ink jet recording method, in which an image is printed on a recording medium with two liquids. In general, an ink jet recording method using two liquids achieves favorable printing by making a reaction liquid and an ink composition in contact with each other.

It is considered that, upon making a reaction liquid and an ink composition in contact with each other, a reactant in the reaction liquid breaks the dispersed state of a colorant and other components in the ink composition, thereby agglomerating them. The ink jet recording method using two liquids provides an image having a high color density without blur or printing irregularity. A color image obtained by the ink jet recording method using two liquids is advantageously prevented from suffering uneven color mixing in the boundary of different colors, i.e., color bleed. However, as disclosed in JP-A-11-348256 and JP-A-8-104000, for printing a favorable image by making a reaction liquid and an ink composition in contact with each other, it is necessary to attain a proper ratio between adhered amounts of the reaction liquid and the ink composition. For retaining the ratio, it is necessary to control the amount of the reaction liquid by scanning multiple times an ink jet recording head on the recording medium. The multiple scanning operation of the ink jet recording head induces reduction in printing speed.

A method of controlling (reducing) equally the amount of the reaction liquid provides no problem in a high density area, but a special process, such as determination of an image edge, is required for such an image as characters. Accordingly, there is a defect (problem) of complicating the structure of the apparatus.

An object of the invention is to provide an ink jet recording apparatus that is capable of controlling an amount of a reaction liquid.

### SUMMARY

According to one aspect of the present invention, there is provided an ink jet recording apparatus comprising: a color processing unit that converts print data to color data; a reaction liquid ejecting unit that has plural nozzles arranged and ejects a reaction liquid onto a recording medium; an ink ejecting unit that has plural nozzles arranged and ejects an ink onto the recording medium based on the color data; a subscanning driving unit that conveys the recording medium having an image formed by the ink ejecting unit; and a controlling unit that controls to a constant value a ratio of an amount of droplets of the reaction liquid ejected by the reaction liquid ejecting unit and a total amount of ink droplets of the ink ejected by the ink ejecting unit, with respect to each of pixels of the image formed on the recording medium.

### DESCRIPTION OF THE DRAWINGS

FIG. 1 is a transversal cross sectional view showing an ink jet recording apparatus according to a first embodiment.

FIG. 2 is a block diagram showing an image formation method according to the first embodiment.

FIG. 3 is an illustration showing a specific example of the image formation method according to the first embodiment.

FIG. 4 is a block diagram showing an image formation method according to a second embodiment.

FIG. 5 is an illustration showing a specific example of the image formation method according to the second embodiment.

FIG. 6 is a table showing results of investigation of relationship between an amount of an ink per one pixel and heave of a recording medium.

FIG. 7 is a block diagram showing an image formation method according to a third embodiment.

FIG. 8 is an illustration showing a specific example of the image formation method according to the third embodiment.

FIG. 9A is an illustration showing an amount of ink droplets ejected by an ink jet recording head of a multiple droplet system.

FIG. 9B is an illustration showing an amount of ink droplets ejected by an ink jet recording head of a volume controlling system.

FIG. 9C is a graph showing driving signal sent to an ink jet recording head of a volume controlling system.

FIG. 9D is a graph showing voltage characteristics of an amount of ink droplets ejected by an ink jet recording head of a volume controlling system.

FIG. 9E is a graph showing pulse width characteristics of an amount of ink droplets ejected by an ink jet recording head of a volume controlling system.

FIG. 10 is a block diagram showing a control system of the ink jet recording apparatus according to the first embodiment.

### DETAILED DESCRIPTION

Embodiments of the invention will be described.

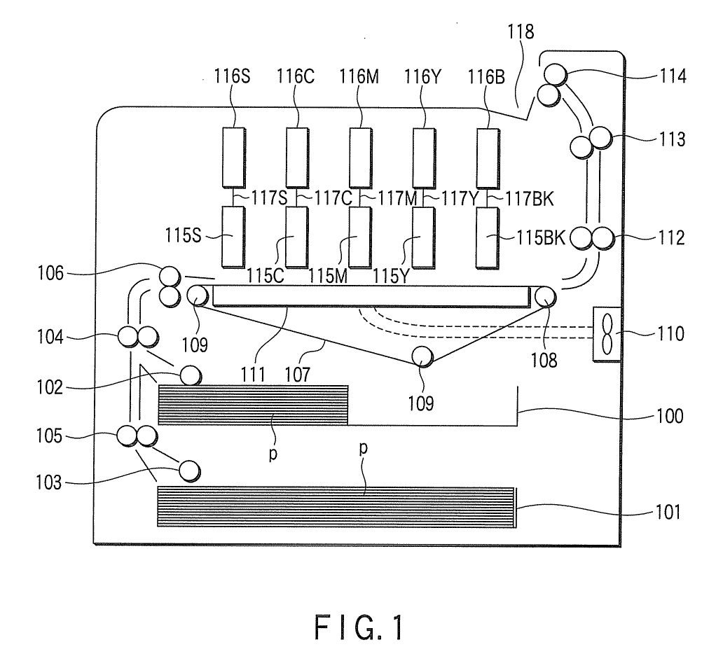

FIG. 1 is a transversal cross sectional view showing an ink jet recording apparatus 1 according to a first embodiment. A first paper cassette 100 and a second paper cassette 101 contain recording media p having different sizes, respectively. A first paper feeding roller 102 takes up the recording medium p corresponding to the selected recording medium size from the first paper cassette 100 and conveys the recording medium p to a first conveying roller pair 104 and a resist roller pair 106. Similarly, a second paper feeding roller 103 takes up the recording medium p corresponding to the selected recording medium size from the second paper cassette 101 and conveys the recording medium p to a second conveying roller pair 105, the first conveying roller pair 104 and the resist roller pair 106.

A conveying belt 107 is applied with tension with a driving roller 108 and two driven rollers 109. The conveying belt 107 has on the surface thereof holes with a prescribed interval. Inside the conveying belt 107, a negative pressure chamber 111, which is connected to a fan 110, is provided for sticking the recording medium p to the conveying belt 107.

The driving roller 108 drives the conveying belt 107 for conveying the recording medium p from the upstream side as a paper feeding unit, in which the resist roller pair 106 is provided, toward the downstream side as a paper delivery unit, in which a first conveying roller pair 112, a second conveying roller pair 113 and a third conveying roller pair 114 are provided. The conveying direction of the recording medium p is the subscanning direction based on the recording operation of the ink jet recording apparatus 1.

Five ink jet recording heads, which each eject inks to the recording medium p based on print data, are disposed above the conveying belt 107 in lines. The ink jet recording heads are arranged from the upstream side to the downstream side in the order of an ink jet recording head 115S ejecting a reaction liquid, an ink jet recording head 115C ejecting a cyan (C) ink, an ink jet recording head 115M ejecting a magenta (M) ink, an ink jet recording head 115Y ejecting a yellow (Y) ink and an ink jet recording head 115Bk ejecting a black (Bk) ink.

The ink jet recording heads 115S, 115C, 115M, 115Y and 115Bk each have a nozzle ejecting the reaction liquid or the ink, which is disposed at a prescribed resolution over the width direction of the recording medium p. In other words, the ink jet recording heads 115S, 115C, 115M, 115Y and 115Bk each are an in-line printing head having plural nozzles, which are not shown in the figure, arranged linearly. The ink jet recording heads 115S, 115C, 115M, 115Y and 115Bk each have nozzles that are arranged in the direction perpendicular to the conveying direction of the recording medium p by the conveying belt 107. The nozzles are arranged to provide a prescribed distance to the recording medium p positioned on the conveying belt 107. The direction, in which the nozzles are arranged, is designated as a main scanning direction.

The ink jet recording apparatus 1 according to the first embodiment has the in-line ink jet recording heads 115S, 115C, 115M, 115Y and 115Bk above the conveying belt 107 for conveying the recording medium p. The ink jet recording heads 115S, 115C, 115M, 115Y and 115Bk each have on the end face thereof nozzles with a prescribed pitch. The ink jet recording heads 115S, 115C, 115M, 115Y and 115Bk each are provided with an actuator at the position opposite to the nozzles via an ink chamber.

The actuator is constituted by a vibration plate attached to the top of the partition wall dividing the ink chambers, and a piezoelectric vibrator. The piezoelectric vibrator is applied with a voltage corresponding to the driving signal constituted by a pixel pattern, thereby deforming the vibration plate. The pressure caused by the change of volume of the ink chamber is transmitted to the ink in the ink chamber, thereby ejecting the ink. The pitch of the nozzles is appropriately selected depending on the density of pixel to be printed. The ink jet recording heads 115S, 115C, 115M, 115Y and 115Bk thus perform the recording operation to the recording medium p based on the input image signal.

Examples of gradation printing using an ink jet printer include an area coverage gradation method, such as a dither method, in which one pixel is formed with a matrix containing plural dots with a constant ink droplet size, and gradation is expressed by changing the number of dots in the pixel. Examples of gradation printing also include a volume control system, in which the density of one dot is changed by varying the ink droplet size. Examples of gradation printing further include a multiple droplet driving system, in which the number of ink droplets that are attached to substantially the same position on the recording medium is changed with a constant ink droplet size, thereby changing the pixel diameter. These methods each have drawbacks and advantages and is appropriately selected depending on purposes.

The ink jet recording heads 115S, 115C, 115M, 115Y and 115Bk are not limited in driving system thereof as far as they are in-line printing heads. Accordingly, examples of the ink jet recording heads 115S, 115C, 115M, 115Y and 115Bk include a system using a thermoelectric conversion device, a system using an electrostriction device, and any of other ink ejecting systems.

The conveying belt 107 and the driving roller 108 constitute a subscanning driving unit that moves the recording medium p and the ink jet recording heads 115S, 115C, 115M, 115Y and 115Bk relatively to each other in the subscanning direction perpendicular to the arrangement direction of the nozzles.

Accordingly, the ink jet recording apparatus 1 according to the first embodiment performs a recording operation to the recording medium p by an in-line system (one-pass recording system).

The ink jet recording heads 115S, 115C, 115M, 115Y and 115Bk each are equipped with an ink cartridge 116S containing the reaction liquid, and a cyan (C) ink cartridge 116C, a magenta (M) ink cartridge 116M, a yellow (Y) ink cartridge 116Y and a black (Bk) ink cartridge 116Bk, which contain inks of respective colors, respectively. The ink jet recording head 115S and the ink cartridge 116S are connected to each other with a tube 117S, the ink jet recording head 115C and the ink cartridge 116C are connected to each other with a tube 117C, the ink jet recording head 115M and the ink cartridge 116M are connected to each other with a tube 117M, the ink jet recording head 115Y and the ink cartridge 116Y are connected to each other with a tube 117Y, and the ink jet recording head 115Bk and the ink cartridge 116Bk are connected to each other with a tube 117Bk.

The ink compositions used in the embodiment designate color ink compositions when color printing is performed, specifically a yellow ink composition, a magenta ink composition, a cyan ink composition and a black ink composition.

The ink composition contains at least a colorant and water. The colorant contained in the ink composition may be either a dye or a pigment.

Examples of the black yellow, cyan and magenta ink compositions are shown below.

Black ink composition
Self-dispersion type carbon black dispersion liquid
(produced by Cabot Speciality Chemicals, Inc.)

| | | |
|---|---|---|
| Solid content of carbon black | 8.0% | by weight |
| Glycerin | 30.0% | by weight |
| Ethylene glycol monobutyl ether | 0.5% | by weight |
| Surfynol 465 | 1.0% | by weight |
| Proxel XL-2(S) | 0.2% | by weight |
| Ion exchanged water | balance (60.3% | by weight) |

Yellow ink composition
Self-dispersion type yellow dispersion liquid
(produced by Cabot Speciality Chemicals, Inc.)

| | | |
|---|---|---|
| Solid content of yellow pigment | 6.0% | by weight |
| Glycerin | 45.0% | by weight |
| Ethylene glycol monobutyl ether | 5.0% | by weight |
| Surfynol 465 | 1.0% | by weight |
| Proxel XL-2(S) | 0.2% | by weight |
| Ion exchanged water | balance (42.8% | by weight) |

Magenta ink composition
Polymer dispersion type magenta dispersion liquid
(produced by Fuji Shikiso Co., Ltd.)

| | | |
|---|---|---|
| Solid content of magenta pigment | 6.0% | by weight |
| Glycerin | 45.0% | by weight |
| Diethylene glycol monobutyl ether | 5.0% | by weight |
| Surfynol 465 | 1.0% | by weight |
| Proxel XL-2(S) | 0.2% | by weight |
| Ion exchanged water | balance (42.8% | by weight) |

Cyan ink composition
Polymer dispersion type cyan dispersion liquid
(produced by Fuji Shikiso Co., Ltd.)

| | | |
|---|---|---|
| Solid content of cyan pigment | 6.0% | by weight |
| Glycerin | 45.0% | by weight |
| Triethylene glycol monobutyl ether | 5.0% | by weight |
| Surfynol 465 | 1.0% | by weight |
| Proxel XL-2(S) | 0.2% | by weight |
| Ion exchanged water | balance (42.8% | by weight) |

The reaction liquid used in the embodiment contains a reactant that breaks the dispersed state of the colorant and the like in the ink composition, thereby agglomerating the colorant component and the like.

The reaction liquid contains as a reactant, for example, a polyvalent metallic salt, a polyamine, a polyamine derivative, an acidic liquid, a cationic surfactant or the like. Preferred examples of the polyvalent metallic salt as the reactant include a water-soluble salt constituted by a divalent or higher metallic ion and an anion capable of being combined with the polyvalent metallic ion.

Specific examples of the polyvalent metallic ion include a divalent metallic ion, such as Ca²⁺, Cu²⁺, Ni²⁺, Mg²⁺, Zn²⁺ and Ba²⁺, and a trivalent metallic ion, such as Al³⁺, Fe³⁺ and Cr³⁺. Examples of the anion include Cl⁻, NO₃⁻, I⁻, Br⁻, ClO₃⁻ and CH₃COO⁻, and among these metallic salts constituted by Ca²⁺ or Mg²⁺ are preferred.

Examples of the reaction liquid include the following.

Reaction liquid

| | |
|---|---|
| Calcium chloride | 25% by weight |
| Triethylene glycol monobutyl ether | 10% by weight |
| Glycerin | 20% by weight |
| Pure water | balance |

For the ink compositions and the reactant, which is a polyvalent metallic salt, the ratio of the attached amount of the reaction liquid to the attached weight of the ink composition (ink composition/reaction liquid) is preferably in a range of from 1.0/0.2 to 1.0/1.1, and more preferably in a range of from 1.0/0.3 to 1.0/0.8.

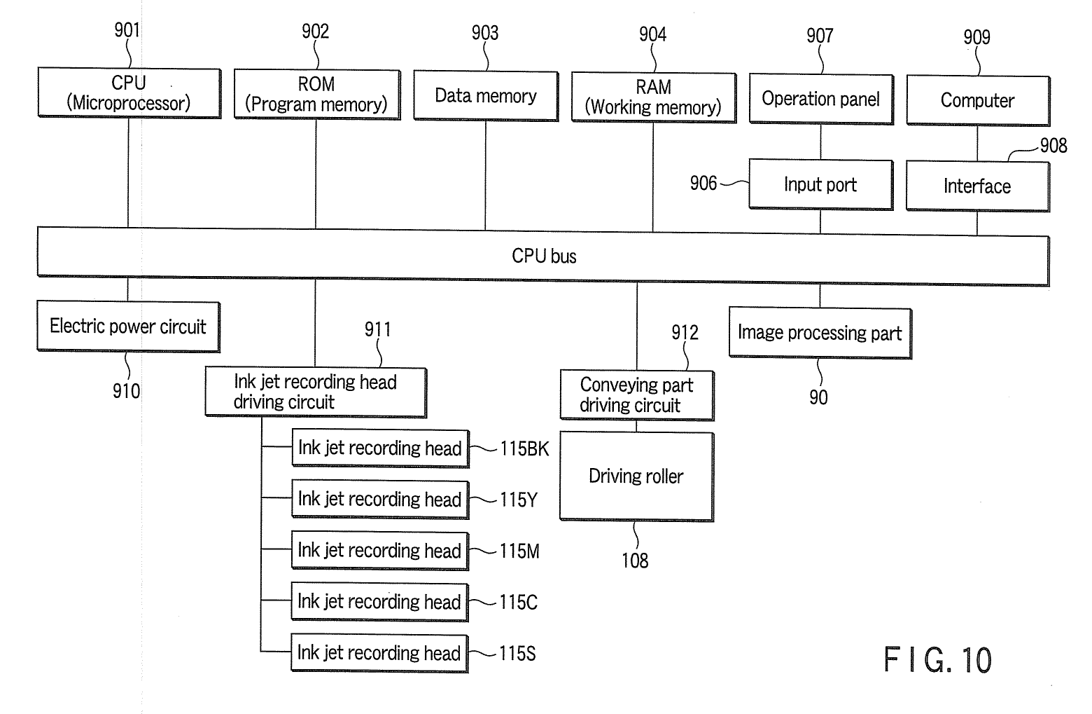

FIG. 10 is a block diagram showing a control system in image formation of the ink jet recording apparatus 1 according to the first embodiment. The control system of the ink jet recording apparatus 1 contains a CPU (microprocessor) 901, a ROM (program memory) 902 and a RAM (working memory) 904 connected via a bus to the CPU 901 to constitute a microcomputer, a data memory 903 having data stored, and an operation panel 907 via an input port 906. The operation panel 907 is provided for setting detailed operation environments of the ink jet recording apparatus 1 and for displaying the operation conditions of the operation process thereof. The operation panel 907 displays or sets by feedback of the operation signals from the driving circuits of the various units of the apparatus.

The CPU (microprocessor) 901 controls an electric power circuit 910, an ink jet recording head driving circuit 911, a conveying unit driving circuit 912 and an image processing unit 90. The CPU 901 drives and controls the various units of the ink jet recording apparatus 1. The CPU 901 controls the various units according to the operation program stored in the ROM 902 or the data memory 903.

The electric power circuit 910 supplies electric power to the various units of the apparatus. The ink jet recording head driving circuit 911 sends driving signals to the ink jet recording heads 115S, 115C, 115M, 115Y and 115Bk. The conveying unit driving circuit 912 controls a roller that drives the driving roller 108 driving the conveying belt 107. The image processing unit 90 processes print data for printing an image received from a computer 909 via an interface 908.

The image formation operation of the ink jet recording apparatus 1 according to the first embodiment will be described. Firstly, the CPU 901 fetches print data or commands for printing on the recording medium p received from the computer 909 via the interface 908, and sends the print data or commands to the RAM 904. The CPU 901 processes the print data with the image processing unit 90 based on the operation program stored in the ROM 902, the command data stored in the data memory 903 or the like. The CPU 901 drives and controls the various units of the ink jet recording apparatus 1 based on the operation process corresponding to the operation program, thereby recording an image on the recording medium p.

The CPU 901 sends the print data, which is processed for an image with the image processing unit 90, to the ink jet recording head driving circuit 911.

Next, the first paper feeding roller 102 or the second paper feeding roller 103 takes up the recording medium p one by one corresponding to the selected recording medium size from the first paper cassette 100 or the second paper cassette 101. The recording medium p is sent to the first conveying roller pair 104 or the second conveying roller pair 105 and the resist roller pair 106.

The resist roller pair 106 corrects skew of the recording medium p and starts to convey the recording medium p at a prescribed timing. The negative pressure chamber 111 forms negative pressure by driving the fan 110, thereby sucking air through holes of the conveying belt 107. The recording medium p is stuck on the conveying belt 107 and conveyed thereby to the position facing the ink jet recording heads 115S, 115C, 115M, 115Y and 115Bk.

The ink jet recording head driving circuit 911 sends driving signals to the ink jet recording heads 115S, 115C, 115M, 115Y and 115Bk based on the print data. The ink jet recording head 115S is connected to the ink cartridge 116S having the reaction liquid charged therein via the tube 117S. The ink jet recording head 115C is connected to the ink cartridge 116C having the cyan ink charged therein via the tube 117C. The ink jet recording head 115M is connected to the ink cartridge 116M having the magenta ink charged therein via the tube 117M. The ink jet recording head 115Y is connected to the ink cartridge 116Y having the yellow ink charged therein via the tube 117Y. The ink jet recording head 115Bk is connected to the ink cartridge 116Bk having the black ink charged therein via the tube 117Bk. The ink jet recording heads 115S, 115C, 115M, 115Y and 115Bk are each appropriately supplied with the reaction liquid or the ink based on the print data. The ink jet recording heads 115S, 115C, 115M, 115Y and 115Bk each selectively eject the reaction liquid or the ink from the nozzles as multiple droplets of the reaction liquid or the ink onto the recording medium p according to the driving signals. The operation is referred to as a main scanning driving process.

The ink jet recording heads 115C, 115M, 115Y and 115Bk herein are each a multiple droplet driving head with an ink ejection amount per droplet of 6 pL. The ink jet recording head 115S herein is a multiple droplet driving head with an reaction liquid ejection amount per droplet of 3 pL.

The CPU 901 drives and controls the driving roller 108 with the conveying unit driving circuit 912. The CPU 901 moves the recording medium p with the driving roller 108 in the subscanning direction perpendicular to the arrangement direction of the nozzles of the ink jet recording heads 115S, 115C, 115M, 115Y and 115Bk. The operation is referred to as a subscanning driving process. The recording process is performed by the main scanning driving process and the subscanning driving process.

The CPU 901 drives the ink jet recording head driving circuit 911 to control the ink jet recording heads 115S, 115C, 115M, 115Y and 115Bk in accordance with the conveying timing of the recording medium p with the conveying unit driving circuit 912, thereby controlling ejection of the reaction liquid and the inks. Accordingly, the distance between the ink jet recording heads 115S, 115C, 115M, 115Y and 115Bk and the recording medium p is maintained to a constant value, for example from 0.5 to 2 mm.

The CPU 901 makes the ink jet recording heads 115S, 115C, 115M, 115Y and 115Bk eject the reaction liquid and the inks of respective colors in accordance with the conveying timing of the recording medium p from the resist roller pair 106. The nozzles of the ink jet recording heads 115S, 115C, 115M, 115Y and 115Bk are arranged over the width direction of the recording medium p, and thus upon conveying the recording medium p, a full color image is formed over the entire surface of the recording medium p. The recording medium p having an image formed thereon is delivered to a paper delivery tray 118 with the first conveying roller pair 112, the second conveying roller pair 113 and the third conveying roller pair 114.

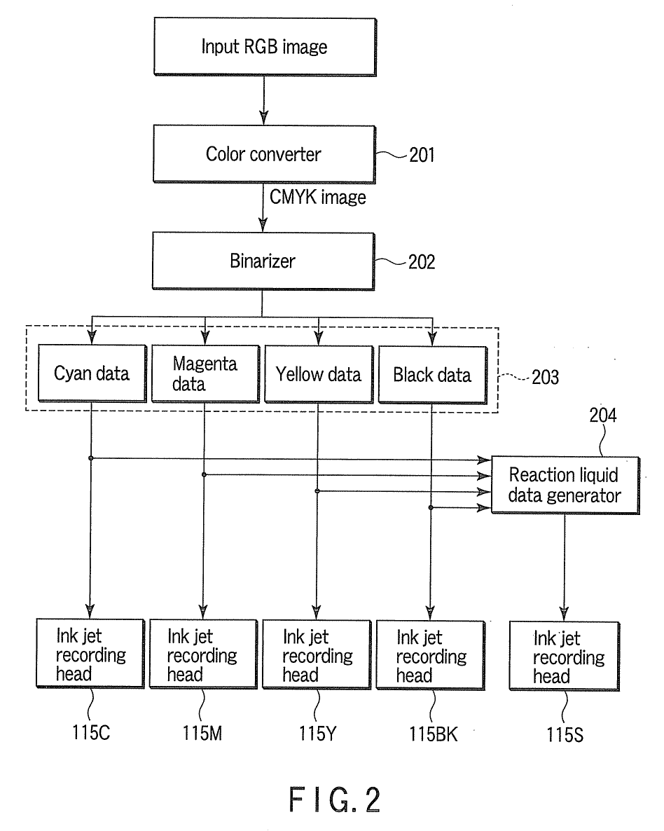

An image formation method according to the first embodiment for printing with the ink jet recording heads 115S, 115C, 115M, 115Y and 115Bk will be described. FIG. 2 is a block diagram showing the image formation method according to the first embodiment. An image processing unit 90 has a color converter 201, a binarizer 202, a color data generator 203 and a reaction liquid data generator 204.

The color converter 201 converts an RGB image, which is print data received from the computer 909 via the interface 908, to a CMYK image. The color converter 201 generates data for each of cyan, magenta, yellow and black by color conversion. The binarizer 202 binarizes the data for each of cyan, magenta, yellow and black converted with the color converter 201. The color data generator 203 generates print data for each of the inks of cyan, magenta, yellow and black binarized with the binarizer 202. The reaction liquid data generator 204 generates reaction liquid data that defines ejection of the reaction liquid ejected by the ink jet recording head 115S. The reaction liquid data generator 204 generates the reaction liquid data based on the sum of the print data for each of cyan, magenta, yellow and black generated by the binarizer 202.

The CPU 901 sends the print data generated by the color data generator 203 and the reaction liquid data generated by the reaction liquid data generator 204 to the ink jet recording head driving circuit 911. The ink jet recording head driving circuit 911 sends driving signals to each of the ink jet recording heads 115S, 115C, 115M, 115Y and 115Bk based on the print data and the reaction liquid data. The ink jet recording heads 115S, 115C, 115M, 115Y and 115Bk each are driven based on the driving signals sent from the ink jet recording head driving circuit 911. The ink jet recording heads 115S, 115C, 115M, 115Y and 115Bk each eject the reaction liquid and the inks, respectively. Consequently, a color image is formed on a desired position on the recording medium p.

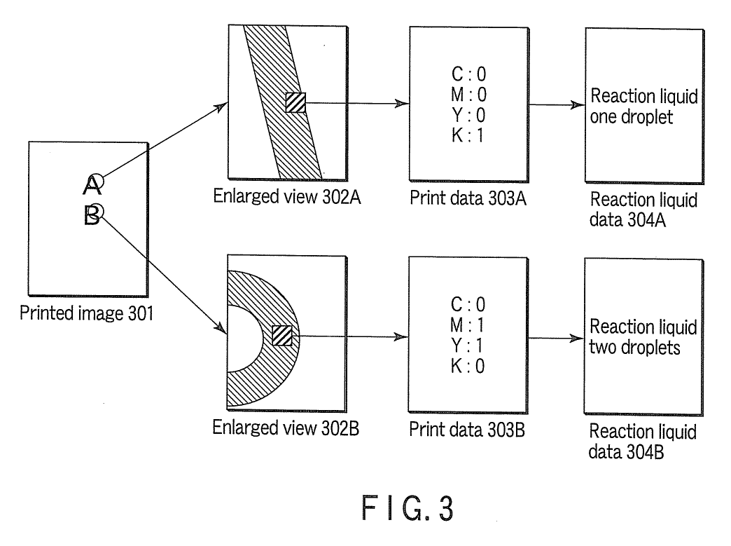

FIG. 3 is an illustration showing a specific example of binarizing one pixel in an image to be printed on the recording medium p. A binarized color image 201 is printed on the recording medium p based on the print data generated by the color data generator 203. The color image 201 includes a black letter “A” and a red letter “B”. A color image 302A is an enlarged view of a part of the letter “A” to be printed on the recording medium p. The hatched part in the color image 302A shows an arbitrary one pixel constituting the black letter “A”.

The color data generator 203 determines the print data 303A of the cyan, magenta, yellow and black inks constituting the one pixel of the hatched part in the color image 303A as (C,M,Y,Bk)=(0,0,0,1). Herein, “1” means that one droplet of the ink is ejected, and “0” means that no ink is ejected. Accordingly, the reaction liquid data generator 204 determines the reaction liquid data for the one pixel of the hatched part in the color image 302A as 1, which is the sum of the print data of cyan, magenta, yellow and black, as shown by the reaction liquid data 304A. In other words, the necessary number of droplets of the reaction liquid is 1 for the one pixel of the hatched part in the color image 302A. Thus, the ink jet recording head 115S ejects for printing one droplet of the reaction liquid onto the one pixel of the hatched part in the color image 302A.

A color image 302B is an enlarged view of a part of the letter “B” to be printed on the recording medium p. The hatched part in the color image 302B shows an arbitrary one pixel constituting the red letter “B”. The color data generator 203 determines the print data 303B of the cyan, magenta, yellow and black inks constituting the one pixel of the hatched part as (C,M,Y,Bk)=(0,1,1,0). Accordingly, the reaction liquid data generator 204 determines the reaction liquid data for the one pixel of the hatched part in the color image 302B as 2, which is the sum of the print data of cyan, magenta, yellow and black, as shown by the reaction liquid data 304B. In other words, the necessary number of droplets of the reaction liquid is 2 for the one pixel of the hatched part in the color image 302B. Thus, the ink jet recording head 115S ejects for printing two droplets of the reaction liquid onto the one pixel of the hatched part in the color image 302B.

In summary, the CPU 901 maintains to a constant value the ratio of the total ink droplet amount, which is the sum of the amounts of the ink droplets ejected by the ink jet recording heads 115C, 115M, 115Y and 115Bk, and the amount of the reaction liquid droplets ejected by the ink jet recording head 115S, with respect to each of pixels. The amount of the droplets ejected by the ink jet recording head 115S per one pixel may be equal to or smaller than the total amount of the ink droplets ejected by the ink jet recording heads 115C, 115M, 115Y and 115Bk.

According to the first embodiment, the total number of ink droplets of the inks of four colors is counted for each pixels of a color image to be printed on the recording medium p, thereby determining the amount of droplets of the reaction liquid to be printed. According to the first embodiment, furthermore, high-speed printing can be performed with a simple structure while maintaining to a proper value the ratio of the droplets of the reaction liquid and the sum of the droplets of the inks of four colors.

An image formation method according to a second embodiment for printing with the ink jet recording heads 115S, 115C, 115M, 115Y and 115Bk will be described.

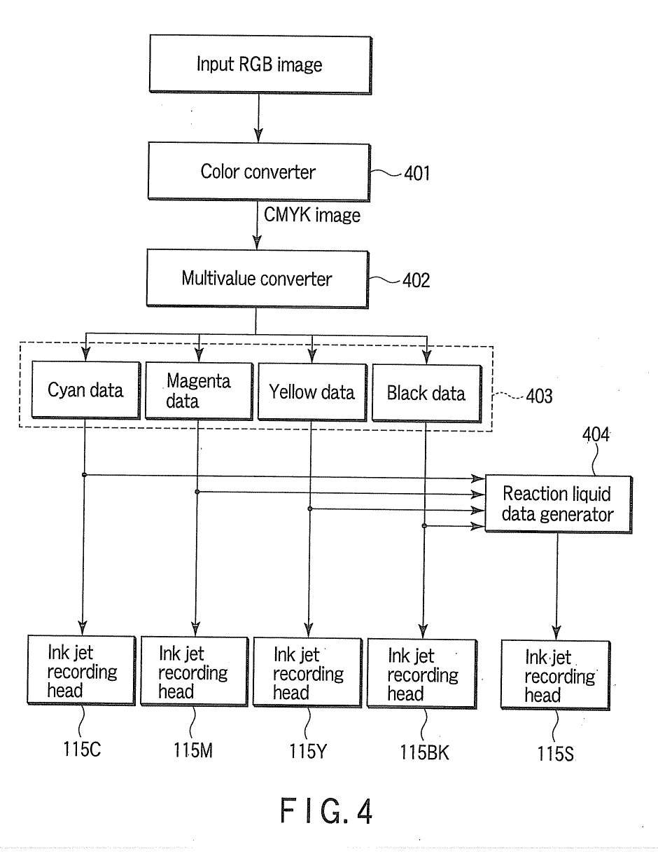

FIG. 4 is a block diagram showing an image formation method according to the second embodiment. An image processing unit 90 has a color converter 401, a multivalue converter 402, a color data generator 403 and a reaction liquid data generator 404. The amount of the reaction liquid ejected by the ink jet recording head 115S and the amounts of the inks ejected by the ink jet recording heads 115C, 115M, 115Y and 115Bk are the same as in the first embodiment. The structure of ink jet recording apparatus 1 and the compositions of the inks of four colors and the reaction liquid are the same as in first embodiment, and the descriptions therefor are omitted herein.

The color converter 401 generates data for each of cyan, magenta, yellow and black from an RGB image, as similar to the color converter 201 in the first embodiment. The multivalue converter 402 converts the data converted by the color converter 401 to multivalue data. An example where the multivalue converter 402 converts the data to eight-level multivalue data is described herein. The color data generator 403 generates print data for each of the inks of cyan, magenta, yellow and black converted to eight-level multivalue data by the multivalue converter 402.

The reaction liquid data generator 404 generates the reaction liquid data based on the sum of the print data for each of cyan, magenta, yellow and black generated by the multivalue converter 402, as similar to the reaction liquid data generator 204 in the first embodiment.

The ink jet recording heads 115S, 115C, 115M, 115Y and 115Bk each are driven based on the print data generated by the color data generator 403 and the reaction liquid data generated by the reaction liquid data generator 404, as similar to the first embodiment. Consequently, a color image is formed on a desired position on the recording medium p.

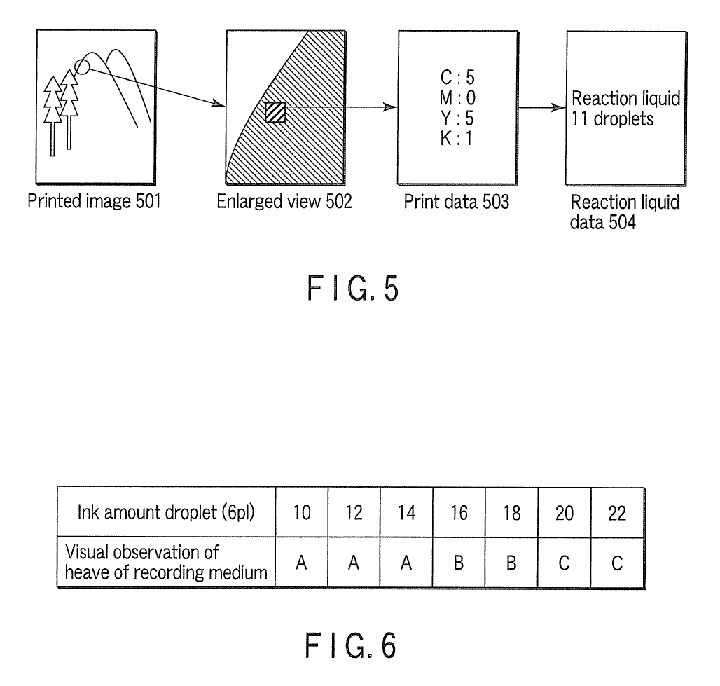

FIG. 5 is an illustration showing a specific example of converting one pixel in an image to be printed on the recording medium p to multivalue data. A multivalue color image 501 is printed on the recording medium p based on the print data generated by the color data generator 403. The color image 501 is an image of natural scenery.

A color image 502 is an image obtained by enlarging a part of the image of natural scenery to be printed on the recording medium p. The hatched part in the color image 502 shows an arbitrary one pixel constituting the image of natural scenery. The color data generator 403 determines the print data 503 of the cyan, magenta, yellow and black inks constituting the one pixel of the hatched part as (C,M,Y,Bk)=(5,0,5,1). The numerals each show the result of eight-level multivalue conversion. The numerals each mean the number of droplets of the ink ejected by the ink jet recording heads 115C, 115M, 115Y and 115Bk of a multiple droplet system. For example, numeral “5” means that five ink droplets are ejected.

Accordingly, the reaction liquid data generator 404 determines the reaction liquid data for the one pixel of the hatched part in the color image 502 as 11, which is the sum of the print data of cyan, magenta, yellow and black, as shown by the reaction liquid data 504. In other words, the necessary number of droplets of the reaction liquid is 11 for the one pixel of the hatched part in the color image 502. Thus, the ink jet recording head 115S ejects for printing 11 droplets of the reaction liquid onto the one pixel of the hatched part in the color image 502.

In summary, the CPU 901 maintains to a constant value the ratio of the total ink droplet amount, which is the sum of the amounts of the ink droplets ejected by the ink jet recording heads 115C, 115M, 115Y and 115Bk, and the amount of the reaction liquid droplets ejected by the ink jet recording head 115S, with respect to each of pixels. The amount of the droplets ejected by the ink jet recording head 115S per one pixel may be equal to or smaller than the total amount of the ink droplets ejected by the ink jet recording heads 115C, 115M, 115Y and 115Bk.

The first and second embodiments will be generalized. The color data generator 403 generates n-level (n≧2) multivalue data for cyan print data, magenta print data, yellow print data and black print data. The ink jet recording head 115C ejects a cyan ink w times (w≦n) onto a pixel that has a value w within n levels set by the color data generator 403 based on the cyan print data. The ink jet recording head 115M ejects a magenta ink x times (x≦n) onto a pixel that has a value x within n levels set by the color data generator 403 based on the magenta print data. The ink jet recording head 115Y ejects a yellow ink y times (y≦n) onto a pixel that has a value y within n levels set by the color data generator 403 based on the yellow print data. The ink jet recording head 115Bk ejects a black ink z times (z≦n) onto a pixel that has a value z within n levels set by the color data generator 403 based on the black print data.

The ink jet recording head 115S ejects a reaction liquid (w+x+y+z) times, which is the sum of the numbers of ejection within n levels per pixel based on the cyan print data, the magenta print data, the yellow print data and the black print data.

According to the second embodiment, the total number of ink droplets of the inks of four colors is counted for each pixels of a color image to be printed on the recording medium p, thereby determining the amount of droplets of the reaction liquid to be printed. According to the second embodiment, furthermore, high-speed printing can be performed with a simple structure while maintaining to a proper value the ratio of the droplets of the reaction liquid and the sum of the droplets of the inks of four colors without the use of any special process.

An image formation method according to a third embodiment for printing with the ink jet recording heads 115S, 115C, 115M, 115Y and 115Bk will be described. The amount of the reaction liquid ejected by the ink jet recording head 115S and the amounts of the inks ejected by the ink jet recording heads 115C, 115M, 115Y and 115Bk are the same as in the first embodiment. The structure of ink jet recording apparatus 1 and the compositions of the inks of four colors and the reaction liquid are the same as in first embodiment, and the descriptions therefor are omitted herein.

Upon printing the inks of four colors on the recording medium p with the ink jet recording heads 115C, 115M, 115Y and 115Bk, the recording medium p undergoes heave due to water content of the inks. FIG. 6 is a table showing results of investigation of relationship between the amount of the ink per one pixel and heave of the recording medium p.

The ink amount is shown in terms of the number of droplets each having an ejection amount of 6 pL. The heave occurring in the recording medium p is evaluated visually. The symbol “A” means that the recording medium p undergoes substantially no heave (acceptable level), “B” means that the recording medium p undergoes slight heave (high possibility of deviating from the acceptable level), “C” means that the recording medium p undergoes significant heave (beyond the acceptable level). As the recording medium p, Toshiba Copy Paper 80 g/m² is used.

As shown in FIG. 6, it is confirmed that heave of the recording medium p becomes conspicuous when the ink amount exceeds 14 droplets per one pixel. The recording medium p starts to undergo heave when it is printed with an ink amount exceeding 14 droplets each having an ink ejection amount of 6 pL. The maximum ink amount that does not provide heave in the recording medium p, i.e., 14 droplets in the third embodiment, is referred to as a maximum injection amount.

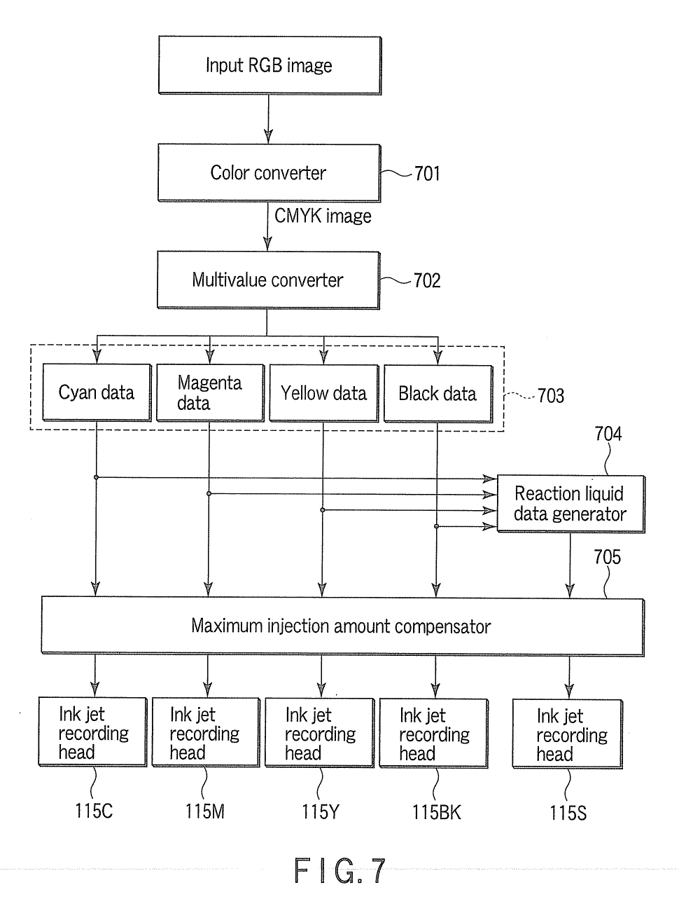

FIG. 7 is a block diagram showing an image formation method according to the third embodiment. An image processing unit 90 has a color converter 701, a multivalue converter 702, a color data generator 703, a reaction liquid data generator 704 and a maximum injection amount compensator 705. The amount of the reaction liquid ejected by the ink jet recording head 115S and the amounts of the inks ejected by the ink jet recording heads 115C, 115M, 115Y and 115Bk are the same as in the first embodiment. The structure of ink jet recording apparatus 1 and the compositions of the inks of four colors and the reaction liquid are the same as in first embodiment, and the descriptions therefor are omitted herein.

The color converter 701 generates data for each of cyan, magenta, yellow and black from an RGB image, as similar to the color converter 201 in the first embodiment. The multivalue converter 702 generates eight-level multivalue data for each of the inks of cyan, magenta, yellow and black, as similar to the multivalue converter 402 in the second embodiment. The color data generator 703 generates print data for each of the inks of cyan, magenta, yellow and black converted to eight-level multivalue data as similar to the color data generator 403 in the second embodiment.

The reaction liquid data generator 704 generates the reaction liquid data based on the sum of the print data for each of the inks of cyan, magenta, yellow and black for each pixel generated by the multivalue converter 702, as similar to the reaction liquid data generator 404 in the second embodiment. The maximum injection amount compensator 705 compensates the print data and the reaction liquid data based on the print data for each of cyan, magenta, yellow and black for each pixel generated by the color data generator 703 and the reaction liquid data generated by the reaction liquid data generator 704. The compensation by the maximum injection amount compensator 705 will be described later.

The CPU 901 sends the print data and the reaction liquid data, which are compensated by the maximum injection amount compensator 705, to the ink jet recording head driving circuit 911. The ink jet recording head driving circuit 911 sends driving signals to each of the ink jet recording heads 115S, 115C, 115M, 115Y and 115Bk based on the compensated print data and the compensated reaction liquid data. The ink jet recording heads 115S, 115C, 115M, 115Y and 115Bk each are driven based on the driving signals sent from the ink jet recording head driving circuit 911. The ink jet recording heads 115S, 115C, 115M, 115Y and 115Bk each eject the reaction liquid and the inks, respectively. Consequently, a color image is formed on a desired position on the recording medium p.

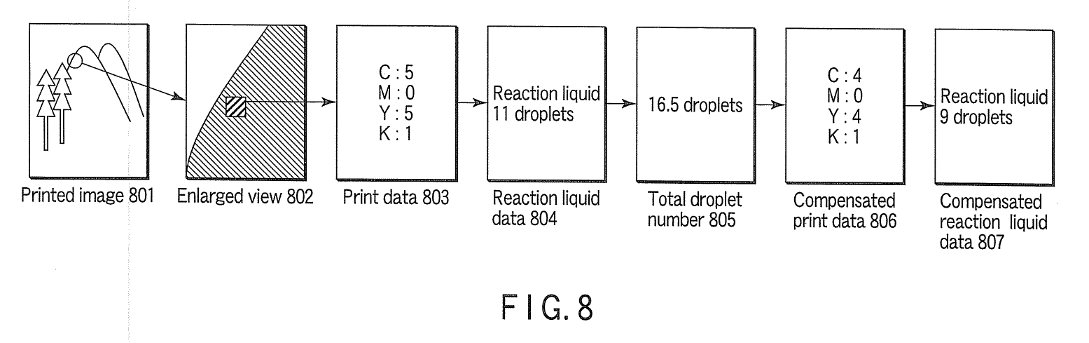

FIG. 8 is an illustration showing a specific example of converting one pixel in an image to be printed on the recording medium p to multivalue data. A multivalue color image 801 is printed on the recording medium p based on the print data generated by the color data generator 703. The color image 801 is an image of natural scenery.

A color image 802 is an image obtained by enlarging a part of an image of natural scenery to be printed on the recording medium p. The hatched part in the color image 802 shows an arbitrary one pixel constituting the image of natural scenery. The color data generator 803 determines the print data 803 of the cyan, magenta, yellow and black inks constituting the one pixel of the hatched part as (C,M,Y,Bk)=(5,0,5,1).

Accordingly, the reaction liquid data generator 704 determines the reaction liquid data for the one pixel of the hatched part in the color image 802 as 11, which is the sum of the print data of cyan, magenta, yellow and black, as shown by the reaction liquid data 804. In other words, the necessary number of droplets of the reaction liquid is 11 for the one pixel of the hatched part in the color image 802.

The maximum injection amount compensator 705 calculates the total droplet number, which is the sum of the numbers of droplets of the inks of four colors and the number of droplets of the reaction liquid ejected onto the one pixel of the hatched part with the ejection amount per droplet being 6 pL. The sum of the numbers of droplets of the inks of four colors is 11 droplets with the ejection amount per droplet being 6 pL since the ejection amount of the ink jet recording heads 115C, 115M, 115Y and 115Bk is 6 pL per droplet. The ejection amount of the ink jet recording head 115S is 3 pL per droplet, and therefore, the number of droplets of the reaction liquid that is converted to the number of droplets with the ejection amount of 6 pL per droplet is 5.5 droplets, which is half of 11 droplets. The maximum injection amount compensator 705 determines that the one pixel of the hatched part is printed with the inks and the reaction liquid in an amount of 16.5 droplets (=11+5.5) with the ejection amount per droplet of 6 pL, as shown by the total droplet number 805.

The recording medium p used in the third embodiment undergoes heave when the total droplet number exceeds 14 per one pixel as shown in FIG. 6. Accordingly, the maximum injection amount compensator 705 determines that it is necessary to compensate the print data for each of the inks of cyan, magenta, yellow and black since the total droplet number is 16.5, which exceeds 14.

The maximum injection amount compensator 705 controls the ink droplet number to such a range that does not produce heave in the recording medium p, i.e., a range of 14 droplets or less per one pixel for the recording medium p used in the third embodiment.

The process of decreasing the total droplet number of 16.5 to 14 or less, i.e., the maximum injection amount or less, by the maximum injection amount compensator 705 will be described. The maximum injection amount compensator 705 multiplies the print data for each of the inks of cyan, magenta, yellow and black by a factor for reducing the droplet number. Specifically, the maximum injection compensator 705 changes the print data for the cyan ink from 5 to 4 (=5×14/16.5) as the compensated print data. Similarly, the maximum injection compensator 705 changes the print data for the magenta ink from 0 to 0 (=0×14/16.5) as the compensated print data, changes the print data for the yellow ink from 5 to 4 (=5×14/16.5) as the compensated print data, and changes the print data for the black ink from 1 to 1 (=1×14/16.5) as the compensated print data. Thus, the maximum injection amount compensator 705 determines that the compensated print data for the inks of cyan, magenta, yellow and black constituting the one pixel of the hatched part is (C,M,Y,Bk)=(4,0,4,1) as shown by the compensated print data 806.

Accordingly, the maximum injection amount compensator 705 determines that the compensated reaction liquid data 807 for the one pixel of the hatched part is 9 (=4+0+4+1), which is the sum of the compensated print data for the inks of cyan, magenta, yellow and black.

The ink droplet number obtained by summing for the inks of four colors is 9 droplets with the ejection amount per droplet of 6 pL. The number of droplets of the reaction liquid that is converted to the number of droplets with the ejection amount of 6 pL per droplet is thus 4.5 droplets, which is half of 9 droplets. The total droplet number for the one pixel of the hatched part is thus 13.5 droplets (=9+4.5). The total droplet number is 13.5, which does not exceeds the maximum injection amount of 14, and thus the recording medium p does not undergo heave. The ink jet recording heads 115S, 115C, 115M, 115Y and 115Bk each are driven based on the compensated print data and the compensated reaction liquid data, which are compensated by the maximum injection amount compensator 705. Consequently, a color image is formed on a desired position on the recording medium p.

The third embodiment will be generalized. The maximum injection amount compensator 705 calculates the droplet number a, which is obtained by converting the droplet number (w+x+y+z) of the reaction liquid ejected by the ink jet recording head 115S in the prescribed ejection amount of the reaction liquid to the droplet number ejected in the prescribed ink ejection amount of the ink jet recording heads 115C, 115M, 115Y and 115Bk. The maximum injection amount compensator 705 then determines as to whether or not the sum (w+x+y+z+a) of the converted droplet number a and the droplet number (w+x+y+z) calculated from the cyan print data, the magenta print data, the yellow print data and the black print data exceeds the upper limit of droplet number b.

When the maximum injection amount compensator 705 determines that (w+x+y+z+a)≦b, the ink jet recording head 115S ejects the reaction liquid (w+x+y+z) times. The ink jet recording head 115C ejects the cyan ink w times, the ink jet recording head 115M ejects the magenta ink x times, the ink jet recording head 115Y ejects the yellow ink y times, and the ink jet recording head 115Bk ejects the black ink z times.

When the maximum injection amount compensator 705 determines that (w+x+y+z+a)>b, the ink jet recording head 115C ejects the cyan ink w×b/(w+x+y+z+a) times, the ink jet recording head 115M ejects the magenta ink x×b/(w+x+y+z+a) times, the ink jet recording head 115Y ejects the yellow ink y×b/(w+x+y+z+a) times, and the ink jet recording head 115Bk ejects the black ink z×b/(w+x+y+z+a) times. In this case, the ink jet recording head 115S ejects the reaction liquid (w+x+y+z)×b/(w+x+y+z+a) times (=(w×b/(w+x+y+z+a))+(x×b/(w+x+y+z+a))+(y×b/(w+x+y+z+a))+(z×b/(w+x+y+z+a))).

As described above, the third embodiment using the maximum injection compensator 705 depends on the kind of the recording medium p since the ink amount per pixel causing heave changes when the kind of the recording medium p changes. Accordingly, a user inputs change of the maximum injection amount, for example, by the operation panel 907, corresponding to the recording medium p on which an image is printed. Consequently, heave formed in the recording medium p can be suppressed even when the recording medium p, on which an image is printed, changes, and furthermore, the print quality can be maintained constant even when the recording medium p changes.

The change of the maximum injection amount may be performed, for example, in such a manner that combination information of the model numbers of the recording medium p and the maximum injection amounts therefor are stored in the RAM 904 in advance, and a user selects the model number of paper (recording medium p) by the operation panel 907, whereby the CPU 901 fetches the maximum injection amount from the RAM 904.

In alternative, for example, such a system may be employed that a sensor is provided for detecting the characteristics of the recording medium p before printing with the ink jet recording head 115S in the process of conveying the recording medium p from the first paper cassette 100 with the first paper feeding roller 102, and the CPU 901 fetches the maximum injection amount from the RAM 904 that stores combination information of the characteristics of the recording medium p and the maximum injection amounts therefor in advance.

According to the third embodiment, the total droplet number of the inks of four colors for each of the pixels of a color image to be printed on the recording medium p is counted, thereby determining the amount of droplets of the reaction liquid to be printed. According to the third embodiment, furthermore, printing operation can be performed at high speed while maintaining appropriately the ratio of the droplet amount of the reaction liquid and the total droplet amount of the inks of four colors, without the use of any special process. According to the third embodiment, moreover, the total ink amount, which is the sum of the droplets of the reaction liquid and the droplets of the ink compositions, per pixel in the print data is prevented from exceeding the maximum injection amount with a simple constitution, whereby the recording medium p is prevented from undergoing heave after printing.

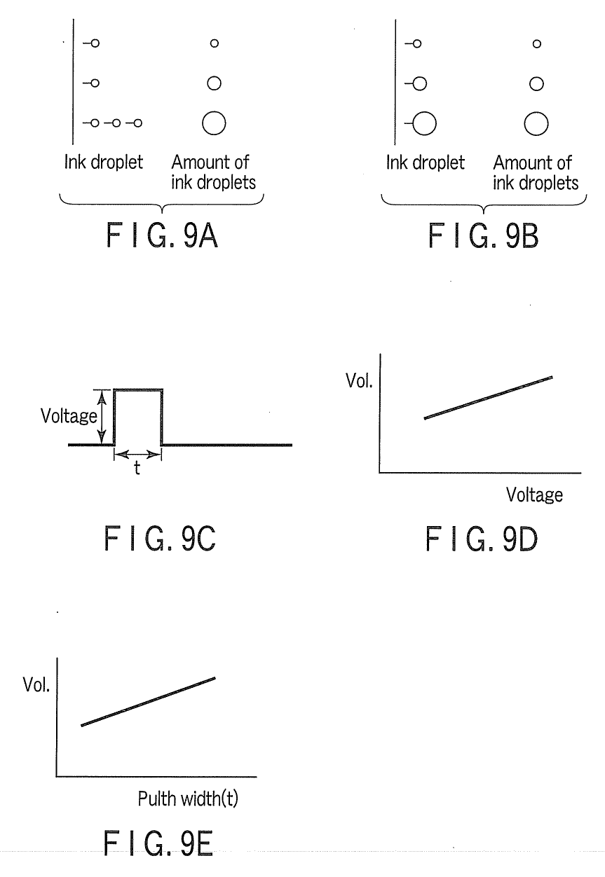

In the first to third embodiments, a multiple droplet system is described, in which the amount of the liquid droplets or the amount of the ink droplets is controlled by ejecting plural times in a constant amount by the ink jet recording heads 115S, 115C, 115M, 115Y and 115Bk, as shown in FIG. 9A. A volume controlling system may also be employed, in which the ink jet recording heads 115S, 115C, 115M, 115Y and 115Bk control the amount of one liquid droplet or the amount of one ink droplet ejected one time, as shown in FIG. 9B. In the volume controlling system, the ink jet recording heads 115S, 115C, 115M, 115Y and 115Bk are driven by the driving signals shown in FIG. 9C. The amount of one liquid droplet or the amount of one ink droplet ejected one time by the ink jet recording heads 115S, 115C, 115M, 115Y and 115Bk are variable by changing the voltage value of the driving signal, as shown in FIG. 9D. Similarly, the amount of one liquid droplet or the amount of one ink droplet ejected one time by the ink jet recording heads 115S, 115C, 115M, 115Y and 115Bk are variable by changing the pulse width of the driving signal, as shown in FIG. 9E. The constitutions of the first to third embodiment can be applied to the volume controlling system, thereby providing the similar advantages.

What is claimed is:

1. An ink jet recording apparatus comprising:
a color processing unit that converts print data to color data;
a reaction liquid ejecting unit that has plural nozzles arranged and ejects a reaction liquid onto a recording medium;
an ink ejecting unit that has plural nozzles arranged and ejects an ink onto the recording medium based on the color data;
a subscanning driving unit that conveys the recording medium having an image formed by the ink ejecting unit; and
a controlling unit that controls to a constant value a ratio of an amount of droplets of the reaction liquid ejected by the reaction liquid ejecting unit and a total amount of ink droplets of the ink ejected by the ink ejecting unit, with respect to each of pixels of the image formed on the recording medium.

2. The apparatus of claim 1, wherein the controlling unit controls the reaction liquid ejecting unit to make the amount of droplets of the reaction liquid equal to or smaller than the total amount of ink droplets, with respect to each of the pixels.

3. The apparatus of claim 1, wherein the ink ejecting unit comprises a cyan ink ejecting unit that ejects a cyan ink, a magenta ink ejecting unit that ejects a magenta ink, a yellow ink ejecting unit that ejects a yellow ink, and a black ink ejecting unit that ejects a black ink.

4. The apparatus of claim 3, wherein the controlling unit determines the total amount of ink droplets of the ink ejected by the ink ejecting unit by summing an amount of ink droplets of the cyan ink ejected by the cyan ink ejecting unit, an amount of ink droplets of the magenta ink ejected by the magenta ink ejecting unit, an amount of ink droplets of the yellow ink ejected by the yellow ink ejecting unit, and an amount of ink droplets of the black ink ejected by the black ink ejecting unit, with respect to each of the pixels.

5. The apparatus of claim 4, wherein:
the reaction liquid ejecting unit ejects the reaction liquid one or more times with a prescribed ejection amount of the reaction liquid to provide the amount of droplets of the reaction liquid,
the cyan ink ejecting unit ejects the cyan ink one or more times with a prescribed ejection amount of the cyan ink to provide the amount of ink droplets of the cyan ink,
the magenta ink ejecting unit ejects the magenta ink one or more times with a prescribed ejection amount of the magenta ink to provide the amount of ink droplets of the magenta ink,
the yellow ink ejecting unit ejects the yellow ink one or more times with a prescribed ejection amount of the yellow ink to provide the amount of ink droplets of the yellow ink, and
the black ink ejecting unit ejects the black ink one or more times with a prescribed ejection amount of the black ink to provide the amount of ink droplets of the black ink.

6. The apparatus of claim 5, wherein the color processing unit generates n-level (n≧2) multivalue data for cyan print data, magenta print data, yellow print data and black print data as the color data.

7. The apparatus of claim 6, wherein:
the cyan ink ejecting unit ejects the cyan ink w times with the prescribed ejection amount of the cyan ink onto a pixel that has a value w within n levels (w≦n) set by the color processing unit based on the cyan print data,
the magenta ink ejecting unit ejects the magenta ink x times with the prescribed ejection amount of the magenta ink onto a pixel that has a value x within n levels (x≦n) set by the color processing unit based on the magenta print data,
the yellow ink ejecting unit ejects the yellow ink y times with the prescribed ejection amount of the yellow ink onto a pixel that has a value y within n levels (y≦n) set by the color processing unit based on the yellow print data,
the black ink ejecting unit ejects the black ink z times with the prescribed ejection amount of the black ink onto a pixel that has a value z within n levels (z≦n) set by the color processing unit based on the black print data, and
the reaction liquid ejecting unit ejects the reaction liquid (w+x+y+z) times, which is the sum of the values within n levels per pixel based on the cyan print data, the magenta print data, the yellow print data and the black print data, with the prescribed ejection amount of the reaction liquid.

8. The apparatus of claim 5, wherein the prescribed amount of the reaction liquid ejected is ½ of the prescribed amount of the ink ejected from the ink ejecting unit per once.

9. The apparatus of claim 7, wherein:
a sum of a droplet number a, which is obtained by converting the droplet number (w+x+y+z) of the reaction liquid ejected by the reaction liquid ejecting unit in the prescribed ejection amount of the reaction liquid to a droplet number ejected in the prescribed ejection amount of the ink, and the droplet number (w+x+y+z) calculated from the cyan print data, the magenta print data, the yellow print data and the black print data does not exceed an upper limit of droplet number b,
the reaction liquid ejecting unit ejects the reaction liquid (w+x+y+z) times,
the cyan ink ejecting unit ejects the cyan ink w times,
the magenta ink ejecting unit ejects the magenta ink x times,
the yellow ink ejecting unit ejects the yellow ink y times, and
the black ink ejecting unit ejects the black ink z times.

10. The apparatus of claim 7, wherein:
a sum of a droplet number a, which is obtained by converting the droplet number (w+x+y+z) of the reaction liquid ejected by the reaction liquid ejecting unit in the prescribed ejection amount of the reaction liquid to a droplet number ejected in the prescribed ejection amount of the ink, and the droplet number (w+x+y+z) calculated from the cyan print data, the magenta print data, the yellow print data and the black print data exceeds an upper limit of droplet number b,
the reaction liquid ejecting unit ejects the reaction liquid (w+x+y+z)×b/(w+x+y+z+a) times,
the cyan ink ejection unit ejects the cyan ink w×b/(w+x+y+z+a) times,
the magenta ink ejection unit ejects the magenta ink x×b/(w+x+y+z+a) times,
the yellow ink ejection unit ejects the yellow ink y×b/(w+x+y+z+a) times, and
the black ink ejection unit ejects the black ink z×b/(w+x+y+z+a) times.

11. The apparatus of claim 9, wherein the apparatus further comprises an input unit that change the upper limit of droplet number b.

12. An ink jet recording method comprising:
converting print data to color data;
controlling to a constant value a ratio of an amount of droplets of a reaction liquid and a total amount of ink droplets ejected onto each of pixels of an image to be formed on a recording medium;
conveying the recording medium, on which the image is to be formed;
ejecting the reaction liquid onto each of pixels on the recording medium in the amount of droplets of the reaction liquid; and
ejecting the ink onto each of pixels on the recording medium in the total amount of ink droplets based on the color data, thereby forming the image.

13. The method of claim 12 comprising:
setting the amount of droplets of the reaction liquid ejected onto each of pixels equal to or smaller than the total amount of ink droplets ejected onto each of pixels.

14. The method of claim 13 comprising:
determining the total amount of ink droplets by summing an amount of droplets of a cyan ink, an amount of droplets of a magenta ink, an amount of droplets of a yellow ink and an amount of droplets of a black ink, with respect to each of the pixels.

15. The method of claim 14 comprising:
controlling the reaction liquid to be ejected one or more times with a prescribed ejection amount of the reaction liquid to provide the amount of droplets of the reaction liquid,
controlling the cyan ink to be ejected one or more times with a prescribed ejection amount of the cyan ink to provide the amount of ink droplets of the cyan ink,
controlling the magenta ink to be ejected one or more times with a prescribed ejection amount of the magenta ink to provide the amount of ink droplets of the magenta ink,
controlling the yellow ink to be ejected one or more times with a prescribed ejection amount of the yellow ink to provide the amount of ink droplets of the yellow ink, and
controlling the black ink to be ejected one or more times with a prescribed ejection amount of the black ink to provide the amount of ink droplets of the black ink.

16. The method of claim 15 comprising:
generating n-level (n≧2) multivalue data for cyan print data, magenta print data, yellow print data and black print data as the color data.

17. The method of claim 16 comprising:
ejecting the cyan ink w times with the prescribed ejection amount of the cyan ink onto a pixel that has a value w within n levels (w≦n) set based on the cyan print data,
ejecting the magenta ink x times with the prescribed ejection amount of the magenta ink onto a pixel that has a value x within n levels (x≦n) set based on the magenta print data,
ejecting the yellow ink y times with the prescribed ejection amount of the yellow ink onto a pixel that has a value y within n levels (y≦n) set based on the yellow print data,
ejecting the black ink z times with the prescribed ejection amount of the black ink onto a pixel that has a value z within n levels (z≦n) set based on the black print data, and
ejecting the reaction liquid (w+x+y+z) times, which is the sum of the values within n levels per pixel based on the cyan print data, the magenta print data, the yellow print data and the black print data with prescribed ejection amount of the reaction liquid.

18. The method of claim 17 comprising:
calculating a droplet number a, which is obtained by converting the droplet number (w+x+y+z) of the ejected reaction liquid in the prescribed ejection amount of the reaction liquid to a droplet number ejected in the prescribed ejection amount of the ink,
determining as to whether or not a sum of the droplet number a and the droplet number (w+x+y+z) calculated from the cyan print data, the magenta print data, the yellow print data and the black print data does not exceed an upper limit of droplet number b, and
when the sum of the droplet number a and the droplet number (w+x+y+z) does not exceed an upper limit of droplet number b,
ejecting the reaction liquid (w+x+y+z) times,
ejecting the cyan ink w times,
ejecting the magenta ink x times,
ejecting the yellow ink y times, and
ejecting the black ink z times.

19. The method of claim 17 comprising:
calculating a droplet number a, which is obtained by converting the droplet number (w+x+y+z) of the ejected reaction liquid in the prescribed ejection amount of the reaction liquid to a droplet number ejected in the prescribed ejection amount of the ink,
determining as to whether or not a sum of the droplet number a and the droplet number (w+x+y+z) calculated from the cyan print data, the magenta print data, the yellow print data and the black print data does not exceed an upper limit of droplet number b, and
when the sum of the droplet number a and the droplet number (w+x+y+z) exceeds an upper limit of droplet number b,
ejecting the reaction liquid (w+x+y+z)×b/(w+x+y+z+a) times,
ejecting the cyan ink w×b/(w+x+y+z+a) times,
ejecting the magenta ink x×b/(w+x+y+z+a) times,
ejecting the yellow ink y×b/(w+x+y+z+a) times, and
ejecting the black ink z×b/(w+x+y+z+a) times.

20. An ink jet recording apparatus comprising:
means for converting print data to color data;
means for having plural nozzles arranged and ejecting a reaction liquid onto a recording medium;
means for having plural nozzles arranged and ejecting an ink onto the recording medium based on the color data;
means for conveying the recording medium having an image formed; and
means for controlling to a constant value a ratio of an amount of droplets of the reaction liquid ejected and a total amount of ink droplets of the ink ejected, with respect to each of pixels of the image formed on the recording medium.
